(19) United States
(12) Patent Application Publication
(10) Pub. No.: US 2007/0183102 A1
(43) Pub. Date: Aug. 9, 2007

(54) Protective device for a consumber branch

(75) Inventor: Johann Seitz, Amberg (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, MUNICH GERMANY (DE)

(21) Appl. No.: 10/591,448

(22) PCT Filed: Mar. 4, 2004
(86) PCT No.: PCT/DE04/00422

§ 371 Date: Sep. 1, 2006

(51) Int. Cl. H02H 7/08

(52) U.S. Cl. 361/23

(57) ABSTRACT

A protective device is for a consumer branch. In order to find an easy, constructive solution which is used to protect the consumer branch in a comprehensive manner, the protective device includes a first protective element to provide motor and line protection, and an integrated second protective element with a fuse, to protect against a short-circuit.

### PRIORITY STATEMENT

This application is the national phase under 35 U.S.C. §371 of PCT International Application No. PCT/DE2004/000422 which has an International filing date of Mar. 4, 2004, which designated the United States of America, the entire contents of which is hereby incorporated herein by reference.

### FIELD

The invention generally relates to a protective device for a load branch circuit.

### BACKGROUND

Load branch circuits nowadays are designed either without a fuse (e.g. with a circuit breaker) or with a fuse. In both types of design it is possible to protect a load branch circuit equipped with mechanical switching devices so that the switching devices are still operational after a short circuit. This is referred to as “coordination type 2” in the relevant product standard IEC 947.

In a load branch circuit without a fuse and having an electronic switching device, the switching device is usually destroyed in the event of a short-circuit unless the power semiconductor is significantly overrated. Hence fuses are mostly used when employing electronic switching devices. In such a load branch circuit, which is fitted with a fuse and has an electronic switching device, “coordination type 2”, can only be achieved by additional components, however, such as special semiconductor fuses or expensive full-range fuses.

### SUMMARY

At least one embodiment of the present invention includes a simple mechanical design that can be used to achieve comprehensive protection of a load branch circuit.

In at least one embodiment, a protective device is provided having a first protective element for providing motor protection and line protection, and having an integral second protective element including a fuse for providing short-circuit protection.

At least one embodiment of the invention includes combining a plurality of protective functions in a single protective device. The protective device according to at least one embodiment of the invention provides not only motor protection and line protection (overload protection), but also short-circuit protection for the whole load branch circuit. By such a combination it is possible to reduce the amount of space required. Since no additional fuse holders are necessary, the required control-cabinet surface area is reduced. Expensive additional protective components and time-consuming wiring of these components is no longer necessary.

Since all the protective elements present in the protective device are coordinated with each other, load branch circuits can also be provided with type-tested protective devices that have been optimally coordinated with each other. The user no longer needs to configure the various protective elements separately to provide the different types of protection. Instead, all the protective functions are combined in a single protective device, these protective functions being coordinated both with each other and with the requirements of the branch circuit to be protected. The solely required protective device, suitable for the given application, can be selected by referring to the motor rating data for example.

Using at least one embodiment of the present invention, it is possible to match the installation dimensions of protective device and switching device so that they can easily be combined with each other as regards their pin width, pin height and pin spacing. Thus, they can be plugged directly onto each other for example, or else can be connected together using suitable adapters. Such an arrangement has the advantage that no additional, costly add-on parts having a different overall device width are required, but the existing system standards can be used.

In an advantageous embodiment of the invention it is provided to design the second protective element such that semiconductor protection also exists for an electronic switching device provided in the load branch circuit. In other words, the second protective element not only enables short-circuit protection for the whole load branch circuit, but at the same time also enables semiconductor protection for electronic switching devices in the load branch circuit. This is achieved in particular by the selection of a suitable fuse, which has a suitable overload capability, for example, for the motor start-up and lower let-through current values to protect the semiconductors. “Coordination type 2” can thereby also be achieved in conjunction with an electronic switching device. Additional components are no longer required for this.

It is particularly advantageous if the fuse can be transferred from its operating position into a maintenance position. This achieves simple electrical isolation for maintenance or repair work. A unit that is manually operable or fitted with a motor drive for hinging out or pulling out the fuse is preferably provided for this purpose.

In a further embodiment of the invention, the protective device is secured against being switched on again accidentally by means of a locking mechanism, for example in the form of a lock, for securing the maintenance position. A further embodiment of the invention, in which an auxiliary switch for signaling the fuse status is provided, has proved well-suited to use in areas particularly relevant to safety. The auxiliary switch is here designed, for example, such that it indicates fuse actuation, for example in conjunction with a signaling element.

In a further embodiment of the invention, the first protective element includes an overload relay. The motor protection and line protection is thereby guaranteed in a simple and yet reliable manner. If the tripping characteristic of the motor protection is coordinated with the overload capability of the electronic switching device, it is no longer necessary to use a mechanical switching device, provided in addition to the electronic switching device, to switch off in the event of an overload. In addition, by adjusting the overload trip response, the rating of the power semiconductor in the electronic switching device connected on the load side can be designed to be significantly cheaper.

The overload relay can be designed as a mechanical bimetal trip or as an electronically implemented version simulating a thermal tripping characteristic. It is irrelevant here whether the overload relay has its own supply or an external supply.

An overload version allowing the rated current to be set over a wide range has proved particularly advantageous in this connection. It is thereby possible to cover a large range of rated motor currents using a relatively small number of different protective devices. It is advantageous here if the first protective element and/or the element for setting the rated current can be replaced as a module. A single base unit can hence be used for a multiplicity of applications.

A thermistor for providing the motor protection function can also be provided instead of the overload relay having bimetal trip. Advantageously, both protective elements are used in parallel. This is particularly useful when a response is also needed to those overheating situations not detected by the overload relay.

### BRIEF DESCRIPTION OF THE DRAWINGS

The present invention is described below with reference to an example embodiment, which is explained in more detail with the aid of drawings, in which:

FIG. 1 shows a schematic diagram of an arrangement having a protective device and an electronic switching device,

FIG. 2 shows a schematic diagram of a protective device in the operating position, and

FIG. 3 shows a schematic diagram of a protective device in the maintenance position.

### DETAILED DESCRIPTION OF THE EXAMPLE EMBODIMENTS

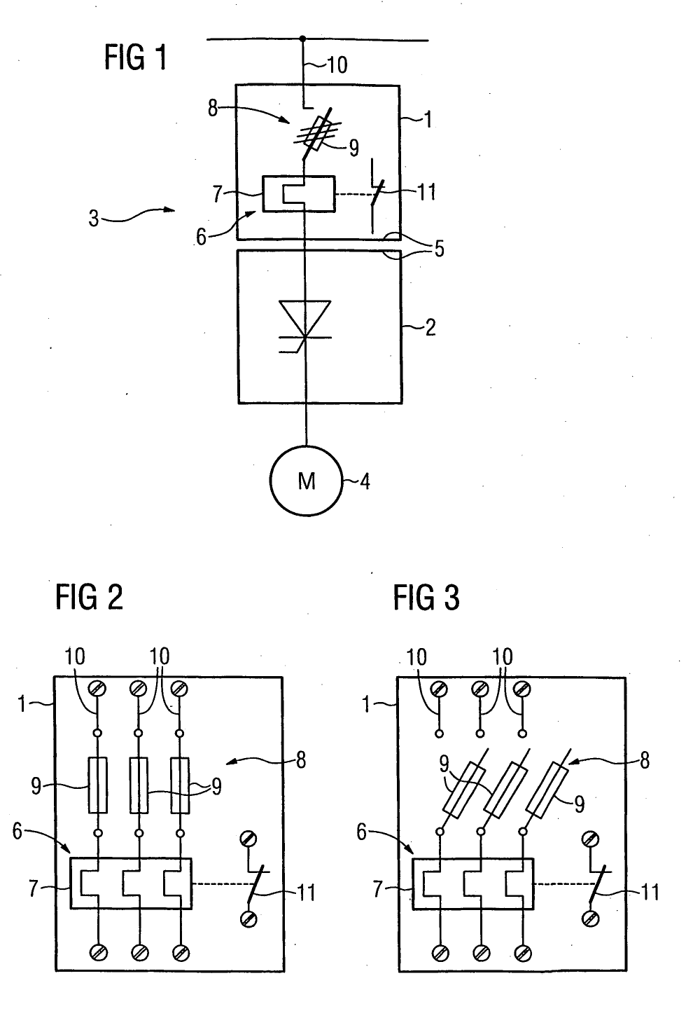

FIG. 1 shows an arrangement having a protective device 1 according to an embodiment of the invention and an electronic switching device 2. The load branch circuit 3 includes, in addition to this arrangement according to an embodiment of the invention, a load in the form of a motor 4.

The installation dimensions of protective device 1 and switching device 2 are matched to each other. In particular, the overall widths 5 of protective device 1 and switching device 2 are the same. The total control-cabinet surface area required for the achieved safety functions is thereby reduced compared to known solutions.

The protective device 1 according to an embodiment of the invention essentially includes a first protective element 6 having an overload relay 7 for providing motor protection and line protection, and an integral second protective element 8 having fuses 9 for providing short-circuit protection.

First protective element 6 and second protective element 8, and hence all the protective functions that can be implemented by the protective device 1, are coordinated with each other so that a user obtains an immediately usable device without any configuration effort. The protective device 1 can be selected on the basis of the rating data of the motor 4.

The protective device 1 according to an embodiment of the invention can also be used in an arrangement having mechanical switching devices (contactors) (not shown). “Coordination type 2” can thereby also be achieved for those arrangements where this was not previously the case.

FIG. 2 shows a protective device 1 according to an embodiment of the invention in the operating position in a highly simplified diagram, where three conductors 10 are protected.

The first protective element 6 includes a three-pole electrothermal overload relay 7. This is used in conjunction with a switch 11 for switching off the electronic switching device 2, connected on the load side in the load branch circuit 3, in the event of an overload, and hence to protect the switching device 2 from being destroyed. Owing to the overload protection function for the motor 4, line protection is thereby also provided at the same time as motor protection. The tripping characteristic of the overload relay 7 is here coordinated with the overload capability of the electronic switching device 2. The power semiconductor in the switching device 2 no longer needs to be overrated owing to the coordination of the overload trip response of the overload relay 7 with the switching device 2.

The second protective element 8 includes fuses 9 for all the conductors 10, said fuses being designed such that in addition to providing short-circuit protection for the whole load branch circuit 3, they also provide semiconductor protection of the electronic switching device 2. In the present example, aM-type partial-range fuses are used for this. These have both a suitable overload capability for motor start-up and low interrupting current values to protect the semiconductor in the switching device 2. The fuses 9 can also be transferred manually from their operating position into a maintenance position, so that simple electrical isolation is possible. Owing to the small size of the fuses 9 used of 10×38 mm, an overall width of 45 mm is possible for the three-phase protective device 1.

FIG. 3 shows a protective device 1 according to an embodiment of the invention in its maintenance position, where the fuses 9 can be hinged out of the operating position.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A protective device for a load branch circuit, comprising:
a first protective element to provide motor protection and line protection; and
an integral second protective element, including a fuse, to provide short-circuit protection.

2. The protective device as claimed in claim 1, wherein the second protective element is designed to provide semiconductor protection for an electronic switching device.

3. The protective device as claimed in claim 1, wherein the fuse is transferrable from its operating position into a maintenance position.

4. The protective device as claimed in claim 3, further comprising:
a locking mechanism to secure the maintenance position.

5. The protective device as claimed in claim 1, further comprising:
an auxiliary switch to signal the status of the fuse.

6. The protective device as claimed in claim 1, wherein the first protective element includes an overload relay.

7. The protective device as claimed in claim 1, wherein a trip response of the first protective element is coordinated with the rating of a switching device.

8. An arrangement comprising:
a protective device as claimed in claim 1; and
a switching device, wherein the protective device and the switching device include standard installation dimensions.

9. The protective device as claimed in claim 2, wherein the fuse is transferable from its operating position into a maintenance position.

10. The protective device as claimed in claim 2, further comprising:
an auxiliary switch to signal the status of the fuse.

11. A protective device for a load branch circuit, comprising:
first means for providing motor protection and line protection; and
an integral second means, including a fuse, for providing short-circuit protection.

12. The protective device as claimed in claim 11, wherein the second means is designed to provide semiconductor protection for an electronic switching device.

13. The protective device as claimed in claim 11, wherein the fuse is transferable from its operating position into a maintenance position.

14. The protective device as claimed in claim 13, further comprising:
means for securing the maintenance position.

15. The protective device as claimed in claim 11, further comprising:
means for signalling the status of the fuse.

16. The protective device as claimed in claim 11, wherein the first means includes an overload relay.

17. The protective device as claimed in claim 11, wherein a trip response of the first means is coordinated with the rating of a switching device.

18. An arrangement comprising:
a protective device as claimed in claim 11; and
a switching device, wherein the protective device and the switching device include standard installation dimensions.

19. The protective device as claimed in claim 12, wherein the fuse is transferable from its operating position into a maintenance position.

20. The protective device as claimed in claim 12, further comprising:
means for signalling the status of the fuse.
